(19) United States
(12) Patent Application Publication
(10) Pub. No.: US 2009/0286020 A1
(43) Pub. Date: Nov. 19, 2009

(54) PHOTOSENSITIVE DRY FILM FOR PRODUCTION OF THREE-DIMENSIONAL MICRO-MOLDED PRODUCT, AND PHOTOSENSITIVE RESIN COMPOSITION

(75) Inventors: Takahiro Asai, Kawasaki-shi (JP); Toru Takahashi, Kawasaki-shi (JP); Hiroki Maeda, Kawasaki-shi (JP)

Correspondence Address: PROCOPIO, CORY, HARGREAVES & SAVITCH LLP, 530 B STREET, SUITE 2100, SAN DIEGO, CA, 92101, US

(73) Assignee: TOKYO OHKA KOGYO CO., LTD., Kawasaki-shi, Kanagawa (JP)

(21) Appl. No.: 11/913,345

(22) PCT Filed: May 11, 2006
(86) PCT No.: PCT/JP2006/309471

§ 371 Date: Nov. 1, 2007

(30) Foreign Application Priority Data
May 12, 2005 (JP) 2005-139912

(51) Int. Cl. B44F 1/06

(52) U.S. Cl. 428/29

(57) ABSTRACT

This invention provides a photosensitive resin composition for the production of a three-dimensional micro-molded product having high sensitivity, which satisfies 0.35≦α≦0.78 wherein α represents a value determined from a relational formula y=αLn(x)±β where β represents an arbitrary real number, x represents the exposure of an actinic radiation, mJ/cm2, and y represents the amount of cured resin by the exposure in terms of the ratio between a coating film thickness before development and a residual film thickness after development, i.e., Δh/h where h represents the coating film thickness before development, μm, and Δh represents the residual film thickness after development, μm, and a photosensitive dry film using the same. The molding accuracy of a three-dimensional micro-molded product having a predetermined three-dimensional face can be improved.

### TECHNICAL FIELD

The present invention relates to a photosensitive dry film and a photosensitive resin composition suited for producing a three-dimensional micro-molded product having a three-dimension face such as micro lenses by using exposure formation technology.

### BACKGROUND ART

Recently, the progress of optical components such as liquid crystal display devices, liquid crystal projectors, and optical communication apparatuses is remarkable, so that it has been required to miniaturize the parts. Essential optical elements for an optical system of such optical components include a micro lens, a microlens array, and a transparent, compact, and lightweight three-dimensional micro-molded product such as a transparent panel of a display device, a transparent substrate, and a transparent partition. This three-dimensional micro-molded product is required to be transparent, compact, lightweight, and also have facilitated formability suitable for high-volume production. To meet such requirements, these three-dimensional micro-molded products are produced by using a photosensitive resin composition as a material, forming this photosensitive resin composition to have a constant thickness, conducting pattern exposure in accordance with the objective shape such as lenses on the obtained photosensitive resin layer in a direction of the thickness of the layer, and dissolving uncured parts with a developer to be removed after exposure (for example, see Patent Documents 1 and 3).

In the technology disclosed in Patent Document 1, a photosensitive resin composition is applied to a glass substrate, the obtained photosensitive resin composition layer is overlapped on a transparent plate, and exposure is conducted from the side of this transparence plate. In the technology disclosed in Patent Document 2, a negative resist layer is patterned by exposure and developing, and then the shape of the layer is formed by heat melt flow. In Patent Document 2, a photosensitive dry film used for the negative resist layer is also disclosed. In the technology disclosed in Patent Document 3, a photosensitive resin composition is applied to a transparent substrate, and the obtained photosensitive resin composition layer is exposed from the side of the transparent substrate.

Patent Document 1: Japanese Unexamined Patent Application Publication No. Hei 7-268177

Patent Document 2: Japanese Unexamined Patent Application Publication No. 2002-182388

Patent Document 3: Japanese Unexamined Patent Application Publication No. 2004-334184

### DISCLOSURE OF THE INVENTION

### Problems to be Solved by the Invention

In the technology disclosed in Patent Document 1, it is easy to cause air crumbling or variations in film thickness when the transparent plate is overlapped on the photosensitive compositions (in liquid state), so that there is a problem that the accuracy of a cured latent image by the exposure is insufficient due to air crumbling and variations in film thickness even if the transparent plate can be overlapped.

In the technology disclosed in Patent Document 2, the heat melt characteristics of the negative resist layer after the photo-curing are inferior, and therefore, there is a problem that it is difficult to control form accuracy.

In the technology disclosed in Patent Document 3, the farther away from the side of the transparent substrate, in other words, the closer to the surface of the photosensitive resin composition layer formed by application, the more the oxidative damage occurs, whereby degree of curing is reduced, so that there is a problem that it becomes difficult to satisfactorily control form accuracy since the degree of curing achieved depending on a light exposure varies.

When the three-dimensional micro-molded product having a predetermined three-dimension face is obtained by using the photosensitive resin composition, the photosensitivity of the photosensitive resin composition is an important factor so as to enhance the form accuracy of the molded product. To obtain the three-dimensional micro-molded product having a predetermined three-dimension face such as micro lenses from the photosensitive resin composition, irradiation (exposure) of actinic rays is conducted so that light volume varies along the planer orientation of the photosensitive resin composition layer formed to have a constant thickness. There are two methods to achieve variation of this light exposure as follows: One is an exposure method by using a mask in which a pattern for controlling the transmissivity of an irradiating light is formed, and irradiating actinic rays of the predetermined light volume on the whole area via this mask. The other exposure method is a method for scanning actinic ray beams continuously while the light volume is varied along the front or back face of the photosensitive resin composition layer.

The exposure for the three-dimensional molding is conducted based on data obtained by specifying actinic irradiation parts (molding region) for the photosensitive resin composition layer, and determining the light exposure distribution required for the whole area of the specified part to be irradiated. A part with less light exposure becomes a part having a smaller thickness, and a part with greater light exposure becomes a part having a greater thickness. In other words, a linear inclined surface is formed when cured film thickness varied in an equal ratio, while a curved surface such as the lens spherical surface is formed when the cured film thickness is increased abruptly and then gradually. Thus, the cured latent image of the three-dimensional molded product having a three-dimension face such as a lens spherical surface is formed on the photosensitive resin composition layer, by setting exposure that is vertical with respect to two-dimensional surface (in the thickness direction of the photopolymer resin layer) so that the light exposure continuously varies along the plane face of the two-dimensional surface.

After the cured latent image was formed, the three-dimensional molded product typified by a micro lens can be obtained by washing the photosensitive resin composition layer with a developing solution and remove non-cured part thereby.

In the three-dimensional molded product provided from the photosensitive resin composition as described above, to enhance the accuracy of the three-dimension face, in other words to enhance formation accuracy, it is important that the cured film thickness for attaining a three-dimension face can be freely controlled by means of the light exposure. It is desirable that the curing thickness when a light exposure was continuously varied on the photosensitive resin composition layer to be used is varied in a linear proportion as much as possible. When actinic rays were exposed on the photosensitive resin composition layer, the more the cured film thickness is varied in a linear proportion to the rectilinear variation of the light exposure, the easier and more precisely it can be controlled by exposure.

The present invention was made in view of the abovementioned circumstances, and an object thereof is to provide a photosensitive resin composition which can improve formation accuracy of a three-dimensional micro-molded product having a predetermined three-dimension face, and a dry film using the same.

### Means for Solving the Problems

As the inventors have conducted extensive experiments and studies to solve the abovementioned problems, they have found the followings.

Accordingly, it was proven that as photosensitivity characteristic required for a photosensitive resin composition so as to obtain a three-dimensional micro-molded product with high accuracy, it is important that the cured film thickness varies in a linear proportion as much as possible to rectilinear variation of the light exposure as described above, and has selectivity in a ratio of the variation. More specifically, it has been proved that a relationship between the light exposure and the cured film thickness merely in a linear proportion as much as possible is not satisfactory, and a slope on a graph showing their proportional relationship should fall within the predetermined range.

Even if the relationship between the light exposure and the cured film thickness is in a linear proportion as much as possible, it exhibits gradual curvilinearity instead of complete linearity according to the photosensitive resin composition including a plurality of components. Then, the proportional curve within a range where a practical three-dimensional micro-molded product is obtained with high accuracy and sufficient reproducibility is determined, and then standardized to avoid a variation by measure. For the standardization, logarithm of light exposure x (mJ/cm²) is represented by Ln(x), and the cured film thickness (resin cured amount) to the light exposure is represented by the ratio (y=Δh/h) of the residual film thickness Δh (μm) after development to the coating film thickness h (μm) before development. As a result, it has been proved that the abovementioned proportional relationship exhibits linearity, and has a constant slope range. In view of the object of the invention, y=0.4897Ln(x)−0.8846 is most preferable, and it has been proved that the allowable range of this most preferred slope coefficient of 0.4897 is 0.35≦α≦0.78 practically.

A proportional relationship between the light exposure and the cured film thickness, and the slope range are obtained at an exposure wavelength of 390 to 430 nm under standard development conditions, i.e., for the same period as a development break with 1% by mass of an aqueous sodium carbonate solution prepared to give the liquid temperature of 30° C. Thus, the proportional relationship between the light exposure and the cured film thickness, and the slope range may need to be corrected to some extent when the exposure wavelength greatly shifts, or the development condition departs from the standard one. However, it was confirmed that a photosensitive resin composition that can be suitably used in a back face exposure method, for example, in the case of a micro lens as the three-dimensional micro-molded product with its lens curved surface exemplified as the surface, in which exposure is conducted from back face of the photopolymer resin layer, and a cured latent image of the micro lens is formed thereby, can be obtained as well as a dry film using the photosensitive resin composition by controlling a resin characteristics to fall within the above range. Conventionally, no dry film consisting of a resin composition suitable for obtaining a micro-molded product having the particular three-dimensional surface such as lens curved surface has been provided by the back face exposure method. Thus, production of the three-dimensional micro-molded product with high efficiency, high accuracy, and favorable reproducibility is enabled using a back face exposure method by providing a dry film obtained using a photosensitive resin composition with the abovementioned requirements.

To obtain a photosensitive resin composition having the proportional relationship between the light exposure and cured film thickness, and the slope range as described above, it is necessary, in a photosensitive resin composition including a resin component containing a polymerizable monomer having at least one functional group as a main component, and a photoinitiator, that at least either of a dialkylbenzophenone-based compound and a hexaarylbisimidazole-based compound is included as the photoinitiator. In addition, it is desirable that the polymerizable monomer include at least one kind of a compound having a polymerizable tetra- or higher-functional ethylenic unsaturated group which in one molecule.

The dry film is constituted with a cover film, the photosensitive resin composition layer, and a protective film. The dry film having this constitution can be obtained by applying the photosensitive resin composition on the cover film, drying to form the photosensitive resin composition layer on the cover film, and laminating the protective film for protecting the exposed surface of this photosensitive resin composition layer.

The present invention was made based on the aforementioned findings. More specifically, the photosensitive dry film for producing the three-dimensional micro-molded product according to the present invention includes at least a cover film and a photosensitive resin composition layer formed thereon, wherein a cured latent image of the three-dimensional micro-molded product is formed inside by irradiating actinic rays from the side of a transparent substrate so that a light volume varies along the plane surface of the transparent substrate after the photosensitive resin composition layer is laminated on the transparent substrate, and the photosensitive resin composition layer is formed by applying a photosensitive resin composition containing a resin component containing a polymerizable monomer having at least one functional group as a main component, and a photoinitiator, followed by drying thereof.

The dry film has specific exposure characteristics, whereby the three-dimensional micro-molded product such as a micro lens can be produced with high efficiency and high accuracy by the back face exposure method. More specifically, for the photosensitive resin composition, the cured film is formed by light curing of the coating film at an exposure wavelength of 405 nm, and developing under a development condition, for the same period as a development break with 1% by mass of an aqueous sodium carbonate solution prepared to give the liquid temperature of 30° C. Thus resulting cured film has exposure characteristics in which when a light exposure is represented by x (mJ/cm²), and the cured film thickness to the light exposure is represented by the ratio (y=Δh/h) of the residual film thickness Δh (μm) after development to the coating film thickness h (Δm) before development, the relationship between logarithm of x (Ln(x)) and y is represented by y=α·Ln(x)≦β, and α falls within the range of 0.35≦α≦0.78 (βis a real number).

In order to impart the exposure characteristics to the photosensitive resin composition, it is preferred that the photoinitiator in components contains at least either of a dialkylbenzophenone-based compound and a hexaarylbisimidazole-based compound.

In addition, it is preferable that the polymerizable monomer includes at least one kind of a compound having a polymerizable tetra- or higher-functional ethylenic unsaturated group in one molecule.

The photosensitive resin composition according to the present invention is not only preferably used for obtaining the photosensitive dry film, but also useful as the photosensitive resin composition that forms a suitable coating film by generally using a exposure formation method without a limitation to a back face exposure method and front face exposure method. Such a photosensitive resin composition is characterized by having a photosensitivity of 0.35≦α≦0.78 when a light exposure of actinic rays (mJ/cm²) irradiated to the composition is represented by x, and a cured film thickness (resin cured amount) to the light exposure is represented by a ratio (y=Δh/h) of a residual film thickness Δh (μm) after development to a coating film thickness h (μm) before development, whereby the photosensitivity is determined based on the relational expression between x and y, which is y=α·Ln(x)±β (β is an arbitrary real number).

The photosensitive resin composition includes a resin component containing a polymerizable monomer having at least one functional group as a main component, and a photoinitiator. The resin component includes an alkali-soluble resin (A), and a photopolymerizable compound (B). Thus, the photosensitive resin composition, more specifically, is a resin composition having at least the alkali-soluble resin (A), the photopolymerizable compound (B), and a photoinitiator (C) as chemical components. It is preferred that the photoinitiator (C) contains at least either of a dialkylbenzophenone-based compound and a hexaarylbisimidazole-based compound. Since these photoinitiators are superior in action to enhance the absorptivity of actinic rays on the resist surface, the light exposure and the cured resin thickness corresponding thereto can be controlled in a linear proportion by appropriately controlling the amount of the photoinitiator.

### Effects of the Invention

The photosensitive dry film according to the present invention, the lithography formation of the three-dimensional micro-molded product is conducted by the back face exposure method with high efficiency and high accuracy. In addition, according to the three-dimensional micro-molded product of the present invention, the three-dimensional micro-molded product having various three-dimension faces can be produced with high accuracy because cured amount to the actinic light exposure can be readily controlled.

### BRIEF DESCRIPTION OF THE DRAWINGS

FIG. 1 is a graph showing the relationship between the light exposure (mJ/cm²) and the thickness (film thickness: μm) in a width direction of three kinds of three-dimensional micro-molded product that is made of resins respectively obtained in Examples and Comparative Example.

FIG. 2 is a graph showing standardized data of FIG. 1.

### PREFERRED MODE FOR CARRYING OUT THE INVENTION

As described above, the photosensitive resin composition according to the present invention is characterized in that when the light exposure of actinic rays (mJ/cm²) is represented by x, and the cured film thickness (resin cured amount) to the light exposure is represented by the ratio (y=Δh/h) of the residual film thickness Δh (μm) after development to the coating film thickness h (μm) before development, the photosensitivity falls within the range of 0.35≦α≦0.78 determined based on the relational expression between x and y, which is y=α·Ln(x)±β, wherein β is an arbitrary real number.

In the constitution enabling to provide the photosensitive resin composition for producing the three-dimensional micro-molded product of the present invention having the photosensitivity characteristics as described above, preferably a photosensitive resin composition containing a polymerizable monomer having at least one functional group as a main component, and a photoinitiator are included. More specifically, the photosensitive resin composition of the present invention preferably includes at least the alkali-soluble resin (A), the photopolymerizable compound (B), and the photoinitiator (C). The components (A), (B), and (C) are described in detail below.

### Alkali-Soluble Resin (A)

Examples of the alkali-soluble resin (A) may include (meth)acryl based resins, styrene based resins, epoxy based resins, amide based resins, amide epoxy based resins, alkyd based resins, phenol based resins, phenol novolak based resins and cresol novolak based resins. The (meth)acryl based resin is preferable in terms of alkaline development property.

As the above (meth)acryl based resins, those obtained by polymerizing or copolymerizing monomers shown below may be used. These polymerizable monomers may also be included as the component (B) described later. As these polymerizable monomers, for example, (meth)acrylic ester, ethylenic unsaturated carboxylic acid, and other copolymerizable monomers can be preferably used. Specifically, styrene, benzyl (meth)acrylate, cyclohexyl (meth)acrylate, phenoxyethyl (meth)acrylate, phenoxypolyethylene glycol (meth)acrylate, nonylphenoxypolyethylene glycol mono(meth)acrylate, nonylphenoxypolypropylene mono(meth)acrylate, 2-hydroxy-3-phenoxypropyl acrylate, 2-acryloyloxyethyl phthalate, 2-acryloyloxyethyl-2-hydroxyethyl phthalate, 2-methacryloyloxyethyl-2-hydroxypropyl phthalate, methyl (meth)acrylate, ethyl (meth)acrylate, n-propyl (meth)acrylate, i-propyl (meth)acrylate, n-butyl (meth)acrylate, i-butyl (meth)acrylate, sec-butyl (meth)acrylate, tert-butyl (meth)acrylate, 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, 3-ethylhexyl (meth)acrylate, ethylene glycol mono(meth)acrylate, glycerol (meth)acrylate, dipentaerythritol mono(meth)acrylate, dimethylaminoethyl (meth)acrylate, diethylaminoethyl (meth)acrylate, tetrahydrofurfuryl (meth)acrylate, glycidyl (meth)acrylate, 2,2,2-trifluoroethyl (meth)acrylate, 2,2,3,3-trifluoropropyl (meth)acrylate, (meth)acrylic acid, α-bromo(meth)acrylic acid, β-furyl (meth)acrylic acid, crotonic acid, propiolic acid, cinnamic acid, α-cyanocinnamic acid, maleic acid, maleic anhydride, maleic acid monomethyl, maleic acid monoethyl, maleic acid monoisopropyl, fumaric acid, itaconic acid, itaconic anhydride, citraconic acid, citraconic anhydride, and the like are included. Among these, benzyl methacrylate is preferably used from the aspect of transparency.

Examples of other copolymerizable monomers may include fumarate esters, maleate esters, crotonate esters, and itaconate esters obtained by replacing (meth)acrylate with fumarate, maleate, crotonate and itaconate, respectively in the exemplified compounds of (meth)acrylate ester, α-methylstyrene, o-vinyltoluene, m-vinyltoluene, p-vinyltoluene, o-chlorostyrene, m-chlorostyrene, p-chlorostyrene, o-methoxystyrene, m-methoxystyrene, p-methoxystyrene, vinyl acetate, vinyl butyrate, vinyl propionate, (meth)acrylamide, (meth)acrylonitrile, isoprene, chloroprene, 3-butadiene, vinyl-n-butyl ether and the like.

In addition to the polymers/copolymers of the above monomers, it is possible to use cellulose derivatives such as cellulose, hydroxymethylcellulose, hydroxyethylcellulose, hydroxypropylcellulose, carboxymethylcellulose, carboxyethylcellulose and carboxyethylmethylcellulose, and additionally copolymers of these cellulose derivatives with ethylenic unsaturated carboxylic acid or the (meth)acrylate compound. Even more particularly, polyvinyl alcohols such as a polybutyral resin which is a reaction product of the polyvinyl alcohol with butyraldehyde; polyesters in which lactones such as δ-valerolactone, ε-caprolactone, β-propiolactone, α-methyl-β-propiolactone, β-methyl-β-propiolactone, α-methyl-β-propiolactone, β-methyl-β-propiolactone, α,α-dimethyl-β-propiolactone, and β,β-dimethyl-β-propiolactone are ring-opening polymerized; polyesters obtained by condensation reaction of alkylene glycol alone such as ethylene glycol, propylene glycol, diethylene glycol, triethylene glycol, dipropylene glycol, and neopentyl glycol or diols of two or more kinds thereof with a dicarbonic acid such as maleic acid, fumaric acid, glutaric acid, and adipic acid; polyethers such as polyethylene glycol, polypropylene glycol, polytetramethylene glycol, polypentamethylene glycol; polycarbonates which are reaction products of a diol such as bisphenol A, hydroquinone, and dihydroxycyclohexane, with a carbonyl compound such as diphenyl carbonate, phosgene, and succinic anhydride are included. The above component (A) may be used alone or in combination of two or more.

The alkali-soluble resin (A) preferably contains a carboxyl group in terms of alkaline development property. Such a component (A) may be produced by performing radical polymerization of a monomer having a carboxyl group with another monomer. In this case, it is preferable to include (meth)acrylic acid.

### Photopolymerizable Compound (B)

The photopolymerizable compound (B) is so-called a polymerizable monomer and has at least one polymerizable ethylenic unsaturated group in a molecule. This photopolymerizable compound (B) preferably contains “compound (B-1) having a polymerizable tetra- or higher-functional ethylenic unsaturated group”. The hardness of the three-dimensional micro-molded product can be enhanced to a value suitable for a permanent film by containing the compound (B-1)

The “compound (B-1) having a polymerizable tetra- or higher-functional ethylenic unsaturated group” includes for example, pentaerythritol tri(meth)acrylate, pentaerythritol tetra(meth)acrylate, pentaerythritol penta(meth)acrylate, dipentaerythritol penta(meth)acrylate, dipentaerythritol hexa(meth)acrylate, and the like. Among these, dipentaerythritol hexa(meth)acrylate is preferably used. These compounds may be used alone or in combination of two or more.

The amount of the above compound (B-1) to be combined is preferably 20 to 100 parts by mass, and more preferably 40 to 80 parts by mass based on 100 parts by mass of the alkali-soluble resin (A) solid content.

It is preferred that the photopolymerizable compound (B) further contains a compound (B-2) having a bisphenol skeleton. Reactivity is improved by containing the compound (B-2). Examples of the above compound (B-2) having the bisphenol skeleton may include bisphenol A type compounds, bisphenol F type compounds and bisphenol S type compounds. In the present invention, 2,2-bis[4-{(meth)acryloxypolyethoxy}phenyl]propane is preferably included in the bisphenol A type compounds. Specific examples may include, but are not limited to, 2,2-bis[4-{(meth)acryloxydiethoxy}phenyl]propane, 2,2-bis[4-{(meth)acryloxytriethoxy}phenyl]propane, 2,2-bis[4-{(meth)acryloxypentaethoxy}phenyl]propane, 2,2-bis[4-{(meth)acryloxydecaethoxy}phenyl]propane, and the like. These compounds may be used alone or in combination of two or more.

In addition, the photopolymerizable compound (B) may contain other well-known compound having a polymerizable ethylenic unsaturated group. For example, polyethylene glycol di(meth)acrylate, polypropylene glycol di(meth)acrylate, polyethylenepolypropylene glycol di(meth)acrylate, ethylene glycol di(meth)acrylate, propylene glycol di(meth)acrylate, polyethylenetrimethylolpropane di(meth)acrylate, trimethylolpropane tri(meth)acrylate, trimethylolpropaneethoxy tri(meth)acrylate, trimethylolpropanediethoxy tri(meth)acrylate, trimethylolpropanetriethoxy tri(meth)acrylate, trimethylolpropanetetraethoxy tri(meth)acrylate, trimethylolpropanepentaethoxy tri(meth)acrylate, tetramethylolmethane tri(meth)acrylate, tetramethylolmethanete tetra(meth)acrylate, tetramethylolpropane tetra(meth)acrylate, 2-phenoxy-2-hydroxypropyl (meth)acrylate, 2-(meth)acroyloxy-2-hydroxypropyl phthalate, 2-(meth)acroyloxyethyl-2-hydroxyethyl phthalate, a compound obtained by reacting a glycidyl group-containing compound with α,β-unsaturated carboxylic acid, urethane monomer, nonylphenyldioxirene (meth)acrylate, γ-chloro-β-hydroxypropyl-α′-(meth)acryloyloxyethyl-o-phthalate, β-hydroxyethyl-β′-(meth)acryloyloxyethyl-o-phthalate, β-hydroxypropyl-β′-(meth)acryloyloxyethyl-o-phthalate, a (meth)alkyl acrylate ester or the like may be contained. Additionally, the monomers exemplified as being capable of combining in the above component (A) may be contained. These compounds may be used alone or in combination of two or more.

Examples of the above glycidyl group-containing compounds may include, but are not limited to, triglycerol di(meth)acrylate.

Examples of the aforementioned urethane monomer may include addition reaction products of a (meth)acryl monomer having an OH group at position β with isophorone diisocyanate, 2,6-toluene diisocyanate, 2,4-toluene diisocyanate or 1,6-hexamethylene diisocyanate; tris[(meth)acryloxy tetraethylene glycol isocyanate]hexamethylene isocyanurate, EO-modified urethane di(meth)acrylate, EO-and PO-modified urethane di(meth)acrylate, and the like.

Examples of the above (meth)acrylic acid alkyl ester may include (meth)acrylic acid methyl ester, (meth)acrylic acid ethyl ester, (meth)acrylic acid butyl ester, (meth)acrylic acid 2-ethylhexyl ester, and the like.

The amount of the component (B) (solid content) to be combined is preferably 20 to 120 parts by mass based on 100 parts by mass of the solid content of the alkali-soluble resin (A). When the amount of the component (B) is too small, the sensitivity is reduced whereas when it is too large, a film forming property is inferior.

The resin components of the photosensitive resin composition according to the present invention is described above. In light of the object of the invention, is desired to contain a compound having a polymerizable tetra- or higher-functional ethylenic unsaturated group in one molecule, and a compound having a bisphenol skeleton as a polymerizable monomer. The hardness of the three-dimensional micro-molded product to be obtained can be enhanced to a value suitable for a permanent film by containing these polymerizable monomers.

### Photoinitiator (C)

The photoinitiator (C) preferably includes a hexaarylbisimidazole-based compound (C1) or/and a dialkylbenzophenone-based compound (C2). Since these photoinitiators have superior light absorption characteristics particularly on the resist surface, high surface formation accuracy can be achieved also when back face exposure was performed. Furthermore, by having the hexaarylbisimidazole based compound (C1), particularly, a beneficial effect on adhesion and resolution may be exhibited.

The hexaarylbisimidazole based compound (C1) means a dimer compound of imidazole in which all hydrogen atoms bound to three carbon atoms of an imidazole ring are substituted with aryl groups (including substituted or unsubstituted groups). Specifically, 2-(o-chlorophenyl)-4,5-diphenylimidazole dimer, 2-(o-chlorophenyl)-4,5-di(methoxyphenyl)imidazole dimer, 2-(o-fluorophenyl)-4,5-diphenylimidazole dimer, 2-(o-methoxyphenyl)-4,5-diphenylimidazole dimer, 2-(p-methoxyphenyl)-4,5-diphenylimidazole dimer, 2,4,5-triarylimidazole dimer such as 2,4,5-triarylimidazole dimer, 2,2-bis(2,6-dichlorophenyl)-4,5-diphenylimidazole dimer, 2,2′-bis(o-chlorophenyl)-4,4′,5,5′-tetra(p-fluorophenyl)biimidazole, 2,2′-bis(o-bromophenyl)-4,4′,5,5′-tetra(p-iodophenyl)biimidazole, 2,2′-bis(o-chlorophenyl)-4,4′,5,5′-tetra(p-chloronaphthyl)biimidazole, 2,2′-bis(o-chlorophenyl)-4,4′,5,5′-tetra(p-chlorophenyl)biimidazole, 2,2′-bis(o-bromophenyl)-4,4′,5,5′-tetra(p-chloro-p-methoxyphenyl)biimidazole, 2,2′-bis(o-chlorophenyl)-4,4′,5,5′-tetra(o,p-dichlorophenyl)biimidazole, 2,2′-bis(o-chlorophenyl)-4,4′,5,5′-tetra(o, p-dibromephenyl)biimidazole, 2,2′-bis(o-bromophenyl)-4,4′,5,5′-tetra(o, p-dichlorophenyl)biimidazole, 2,2′-bis(o, p-dichlorophenyl)-4,4′,5,5′-tetra(o, p-dichlorophenyl)biimidazole, and the like are included. Among them, the 2-(o-chlorophenyl)-4,5-diphenylimidazole dimer is preferably used.

The amount of the photoinitiator (C-1) to be combined in the composition is 1 to 30 parts by mass, and more preferably 5 to 15 parts by mass based on 100 parts by mass of the solid content of the alkali-soluble resin (A). When the amount is 1 to 30 parts by mass, superior sensitivity is achieved.

As the dialkyl benzophenone compound (C2), specifically, 4,4′-bis(dimethylamino)benzophenone, 4,4′-bis(diethylamino)benzophenone, 3,3′-dimethyl-4-methoxybenzophenone, 4,4′-bis(dicyclohexylamino)benzophenone, 4,4′-bis(dihydroxyethylamino)benzophenone, 4,4′-bis(dimethoxy)benzophenone, 4,4′-bis(methylethylamino)benzophenone, and the like may be exemplified. Among these, 4,4′-bis(diethylamino)benzophenone is preferably used.

The amount of the photoinitiator (C-2) to be combined in the composition is 0.01 to 5 parts by mass, and more preferably 0.1 to 2 parts by mass based on 100 parts by mass of the solid content of the alkali-soluble resin (A). When the amount is 0.1 to 5 parts by mass, lens formability is excellent.

The photosensitive resin composition may include an additional photoinitiator other than one described above as far as characteristics required for the three-dimensional micro-molded product obtained after formation are not deteriorated. Such a photoinitiator includes, for example, aromatic ketones such as 1-hydroxycyclohexylphenyl ketone, 2,2-dimethoxy-1,2-diphenylethan-1-one, 2-methyl-1-[4-(methylthio)phenyl]-2-morpholinopropan-1-one, 2-benzyl-2-dimethylamino-1-(4-morpholinophenyl)-butan-1-one, 2-hydroxy-2-methyl-1-phenylpropan-1-one, 2,4,6-trimethylbenzoyldiphenylphosphine oxide, 1-[4-(2-hydroxyethoxy)phenyl]-2-hydroxy-2-methyl-1-propan-1-one, 2,4-diethylthioxanthone, 2-chlorothioxanthone, 2,4-dimethylthioxanthone, 1-chloro-4-propoxythioxanthone, 1-(4-isopropylphenyl)-2-hydroxy-2-methylpropan-1-one, 1-(4-dodecylphenyl)-2-hydroxy-2-methylpropan-1-one, 4-benzoyl-4′-methyldimethyl sulfide, p-dimethylaminobenzoic acid ethyl ester, 4-dimethylaminobenzoic acid, methyl 4-dimethylaminobenzoate, ethyl 4-dimethylaminobenzoate, butyl 4-dimethylaminobenzoate, 2-ethylhexyl 4-dimethylaminobenzoate, 2-isoamyl 4-dimethylaminobenzoate, 2,2-diethoxyacetophenone, methyl o-benzoylbenzoate, bis(4-dimethylaminophenyl) ketone, 2,2-diethoxyphenylacetophenone, p-dimethylaminoacetophenone, p-tert-butyltrichloroacetophenone, p-tert-butyldichloroacetophenone, thioxanthone, 2-methylthioxanthone, 2-isopropylthioxanthone, dibenzosuberone, α,α-dichloro-4-phenoxyacetophenone, pentyl 4-dimethylaminobenzoate, benzophenone, N,N′-tetramethyl-4,4′-diaminobenzophenone, N,N′-tetraethyl-4,4′-diaminobenzophenone, 4-methoxyl-4-dimethylbenzophenone, 3,3-dimethyl-4-methoxybenzophenone, 4,4′-bisdiethylaminobenzophenone, 4,4′-dichlorobenzophenone, and 2-benzyl-2-dimethylamino-1-(4-morpholinophenyl)-butanone-1, 2-methyl-1-[4-(methylthio)phenyl]-2-morpholino-propanone-1; quinones such as 2-ethylanthraquinone, phenanthrenequinone, 2-tert-butylanthraquinone, octamethylanthraquinone, 1,2-benzanthraquinone, 2,3-benzanthraquinone, 2-phenylanthraquinone, 2,3-diphenylanthraquinone, 1-chloroanthraquinone, 2-methylanthraquinone, 1,4-naphthoquinone, 9,10-phenanthraquinone, 2-methyl-1,4-naphthoquinone and 2,3-dimethylanthraquinone; benzoin ether compounds such as benzoin methyl ether, benzoin ethyl ether, benzoin phenyl ether, benzoin isopropyl ether, α-methylolbenzoin methyl ether, α-methoxybenzoin methyl ether, benzoin n-butyl ether, and benzoin isobutyl ether; benzoin compounds such as benzoin, methylbenzoin, and ethylbenzoin; benzyl derivatives such as benzyl-β-methoxyethylacetal and benzylmethylketal; acridine derivatives such as 9-phenylacridine, 1,7-bis(9,9′-acridinyl)heptane, 1,5-bis-(9-acridinyl)pentane and 1,3-bis-(9-acridinyl)propane; and coumarin based compounds, and the like.

The amount of the photoinitiator (C) to be combined in the composition is 0.1 to 30 parts by mass, and more preferably 1 to 20 parts by mass based on 100 parts by mass of the solid content of the alkali-soluble resin (A).

### Other Components

In the photosensitive resin composition, organic solvents for dilution of such as alcohols, ketones, acetic acid esters, glycol ethers, glycol ether esters, and petroleum based solvents may be appropriately added if necessary for the purpose of adjusting a viscosity and the like in addition to the above components.

Organic solvents for dilution include, for example, tetrahydrofuran, hexane, heptane, octane, nonane, decane, benzene, toluene, Xylene, benzyl alcohol, methyl ethyl ketone, acetone, methyl isobutyl ketone, cyclohexanone, Methanol, ethanol, Propanol, butanol, hexanol, cyclohexanol, ethylene glycol, diethylene glycol, glycerin, ethylene glycol monomethyl ether, ethylene glycol monoethyl ether, propylene glycol monomethyl ether, propylene glycol monomethyl ether, diethylene glycol monomethyl ether, diethylene glycol monoethyl ether, diethylene glycol dimethyl ether, diethylene glycol diethyl ether, 2-methoxybutyl acetate, 3-methoxybutyl acetate, 4-methoxybutyl acetate, 2-methyl-3-methoxybutyl acetate, 3-methyl-3-methoxybutyl acetate, 3-ethyl-3-methoxybutyl acetate, 2-ethoxybutyl acetate, 4-ethoxybutyl acetate, 4-propoxybutyl acetate, 2-methoxypentyl acetate, 3-methoxypentyl acetate, 4-methoxypentyl acetate, 2-methyl-3-methoxypentyl acetate, 3-methyl-3-methoxypentyl acetate, 3-methyl-4-methoxypentyl acetate, 4-methyl-4-methoxypentyl acetate, methyl lactate, ethyl lactate, methyl acetate, ethyl acetate, propyl acetate, butyl acetate, propylene glycol monomethyl ether acetate, propylene glycol monomethyl ether acetate, methyl propionate, ethyl propionate, methyl benzoate, ethyl benzoate, propyl benzoate, butyl benzoate, methyl butyrate, ethyl butyrate, propyl butyrate, and additionally petroleum based solvents available under trade names such as “Swasol” (Maruzen Petrochemical Co., Ltd.) and “Solvets” (Tonen Petrochemical Co., Ltd.), but are not limited thereto.

Other additives such as adhesion imparting agents, plasticizers, antioxidants, heat polymerization inhibitors, surface tension modifiers, stabilizers, chain transfer agents, anti-foaming agents and flame retardants may also be added appropriately.

The combination of the alkali-soluble resin (A), the photopolymerizable compound (B), and the photoinitiator (C) most preferred as the photosensitive resin composition is a composition in which the component (A): 100 parts by mass (in terms of solid content) of a resin having an average molecular weight of 80,000 of a copolymer in which the mass ratio of benzyl methacrylate to methacrylic acid is 80:20; the component (B): 60 parts by mass of dipentaerythritol hexaacrylate, and 20 parts by mass of EO modified bisphenol A dimethacrylate; and the component (C): 10 parts by mass of 2-(o-chlorophenyl)-4,5-diphenylimidazole dimer, and 0.7 parts by mass of 4,4′-bis(diethylamino)benzophenone are selected because the combination exhibits excellent in all of back face exposure sensitivity, transparency, resolving ability, and hardness of the three-dimensional micro-molded product.

For forming an optically transparent three-dimensional micro-molded product using the photosensitive resin composition including the above-mentioned components, the photosensitive resin composition layer may be formed by directly applying this photosensitive resin composition on a transparent substrate, whereby pattern exposure may be conducted in this photosensitive resin composition layer. However, when efficiency and stability of the production is considered, it is desirable that the photosensitive dry film is made once from this photosensitive resin composition, and then this dry film is attached on the transparent substrate, whereby the photosensitive resin composition layer is constituted. This photosensitive dry film can be preferably used for a back face exposure method in particular. The photosensitive dry film will be described below.

The photosensitive dry film is obtained by at least providing the photosensitive resin composition layer formed from the aforementioned photosensitive resin composition on a support film (cover film). When used, the photosensitive resin composition layer may be easily provided on a transparent substrate by overlapping the revealing photosensitive resin composition layer on the transparent substrate, and subsequently peeling the support film off from the photosensitive resin composition layer.

By the use of the photosensitive dry film, the layer having more excellent film thickness uniformity and surface smoothness can be formed as compared with the case of forming the photosensitive resin layer by directly applying the photosensitive resin composition on the transparent substrate.

The support film used for producing the photosensitive dry film is not particularly limited as long as the photosensitive resin composition layer formed on the support film can be peeled easily off from the support film, and the film is a mould releasing film capable of transferring the photosensitive resin composition layer to the surface of a transparent substrate such as glass and the like. Examples of such a support film may include flexible films composed of films of synthetic resins such as polyethylene terephthalate, polyethylene, polypropylene, polycarbonate and poly vinyl chloride with a film thickness of 15 to 125 μm. It is preferable that a mould releasing treatment is given to the above support film if necessary to facilitate the transfer.

When the photosensitive resin composition layer is formed on the support film, the photosensitive resin composition is prepared, and is applied on the support film so that the dried film thickness is 10 to 100 μm using an applicator, a bar coater, a wire bar coater, a roll coater, a curtain flow coater, or the like. In particular, the roll coater is preferable because excellent film thickness uniformity is achieved, and the thick film can be formed efficiently.

In the photosensitive dry film, the protective film may be further provided on the photosensitive resin composition layer. Protection by the protective film makes storage, transport and handling easy. The photosensitive dry film protected by the protective film may be previously produced and stored for a predetermined period although there is an expiration date for use. Thus, in case of production of the optically transparent three-dimensional micro-molded product, it can be used immediately, whereby the molded product forming process can be streamlined. As this protective film, polyethylene terephthalate film, polypropylene film and polyethylene film with a thickness of about 15 to 125 μm to which silicone has been coated or burned in are suitable.

To make the three-dimensional micro-molded product using this photosensitive dry film, the protective film is first peeled off from the photosensitive dry film, the exposed photopolymer resin layer side is overlapped on the transparent substrate (e.g., glass substrate), and then the photosensitive dry film is adhered on the substrate. When adhered, typically a thermal compression mode in which the substrate has been previously heated and the photosensitive dry film placed thereon is pressed is employed.

Subsequently, in the photosensitive resin composition layer on which a support film was laminated, while irradiation light volume (light exposure) is varied in proportion to the thickness profile of the objective three-dimensional micro-molded product (e.g., a micro lens), an actinic ray is irradiated from the glass substrate side along the planer direction and in a vertical direction of the transparent substrate (in the same way as described above). As the actinic ray, ultraviolet rays such as a low-pressure mercury lamp, a high-pressure mercury-vapor lamp, an ultrahigh pressure mercury lamp, an arc lamp, and h-line, a xenon lamp, an excimer laser, X-rays, electron beams are used. The cured latent images of the objective three-dimensional micro-molded product are formed in the photosensitive resin composition layer by this exposure. The hardened face of this cured latent image is formed with high accuracy by the photosensitivity characteristic that the photosensitive composition of the present invention has. It is important for formation of the cured latent image of the three-dimensional micro-molded product that necessitates the accuracy of surface shape of the micro lens and the like, in particular.

After the above exposure, the support film is peeled, followed by development to selectively remove an unexposed area of the photosensitive resin composition layer, whereby a pattern (for example, lens shape) is formed with the remaining photosensitive resin layer at the exposed area.

As a process after the development, it is desirable that the molded product is further cured by heating at around 60 to 250° C. if necessary.

### EXAMPLES

In the following, Examples of a photosensitive resin composition for producing a three-dimensional micro-molded product according to the present invention are described in detail with reference to figures. This invention is not limited to these Examples.

### Examples and Comparative Example

A micro lens was made by using a photosensitive dry film constituted with a cover film, a photosensitive resin composition layer, and a protective film. Components of the photosensitive resin composition were: a copolymer (average molecular weight of 80,000; 50% by mass of a MEK solution) at a mass ratio being 80:20 of benzyl methacrylate: methacrylic acid; dipentaerythritol hexaacrylate (the compound (B-1) having a polymerizable tetra- or higher-functional ethylenic unsaturated group in one molecule); NK-ester BPE-100 (the compound (B-2) having a bisphenol skeleton manufactured by Shin-Nakamura Chemical Co., Ltd.); EAB-F (4,4′-bis(diethylamino)benzophenone manufactured by Hodogaya Chemical Co., Ltd.); and B-CIM (2-(o-chlorophenyl)-4,5-diphenylimidazolyl dimer manufactured by Hodogaya Chemical Co., Ltd.)

The benzyl methacrylate and the methacrylic acid are polymer components for attaining transparency as the micro lens. In addition, the dipentaerythritol hexaacrylate and the compound having a bisphenol skeleton are monomer components for increasing the hardness as a permanent film in a suitable degree for a micro lens. In addition, the EAB-F is a polymerization initiator of a radical polymerization system in response to an exposure wavelength of 405 nm (mercurial h-line), and the BCIM is a sensitizer thereof. The component ratios of these photosensitive resin compositions are described as follows. Only EABF was adjusted to give three different amounts of 0.6 (Example 1), 1.2 (Example 2), and 2.4 (Comparative Example 1) parts by mass in the compositions as follows.

### Components of Photosensitive Resin Composition

A copolymer (average molecular weight of 80,000; 50% by mass of a MEK solution) at a mass ratio being 80:20 of benzyl methacrylate: methacrylic acid: 100 parts by mass (in terms of solid content) Dipentaerythritol hexaacrylate (the compound (B-1) having a polymerizable tetra- or higher-functional ethylenic unsaturated group in one molecule) : 60 parts by mass, NK-ester BPE-100 (the compound (B-2) having a bisphenol skeleton manufactured by Shin-Nakamura Chemical Co., Ltd.): 20 parts by mass EAB-F (4,4′-bis(diethylamino) benzophenone manufactured by Hodogaya Chemical Co., Ltd.): the amount is varied by each composition B-CIM (2-(o-chlorophenyl)-4,5-diphenylimidazolyl dimer manufactured by Hodogaya Chemical Co., Ltd.): 10 parts by mass

Three kinds of the photosensitive resin compositions were applied on cover films respectively so that the thickness after the drying was 25 μm (transparent polyester film: thickness of 20 μm), And then dried, whereby the photosensitive resin composition layers were formed. Protective films were attached respectively thereon to obtain three kinds of photosensitive dry films (Examples 1 and 2, and Comparative Example 1).

The protective films were peeled off from the photosensitive dry film to expose the photosensitive resin composition layers, and then the exposed surfaces were adhered on a glass substrate (transparent substrate).

The mask having a pattern formed (transmission light volume was varied in equal ratio continually) for actualizing an elliptical micro lens in the glass substrate side was overlapped thereon, and then photoirradiation was conducted at a wavelength of 405 nm. Exposure intensity was 50 mJ/cm²·sec at the transparent substrate surface, and illumination intensity was 13 kw/cm² at this time.

After exposure, a light mask was peeled off, the photosensitive resin composition layer and the cover film were peeled off the glass substrate while the photosensitive resin composition layer was unified with the cover film, and then immersed in 1% of an aqueous sodium carbonate solution (Na₂CO₃) adjusted at 30° C. for 240 seconds, whereby a non-cured part of the photosensitive resin composition layer was dissolved to be removed. After development treatment with this sodium carbonate water solution, the photosensitive resin composition layer as well as the cover film were washed for 60 seconds with pure water. Then, heating treatment was conducted at 130° C. for one hour to enhance degree of curing of the photosensitive resin composition layer cured to have the pattern.

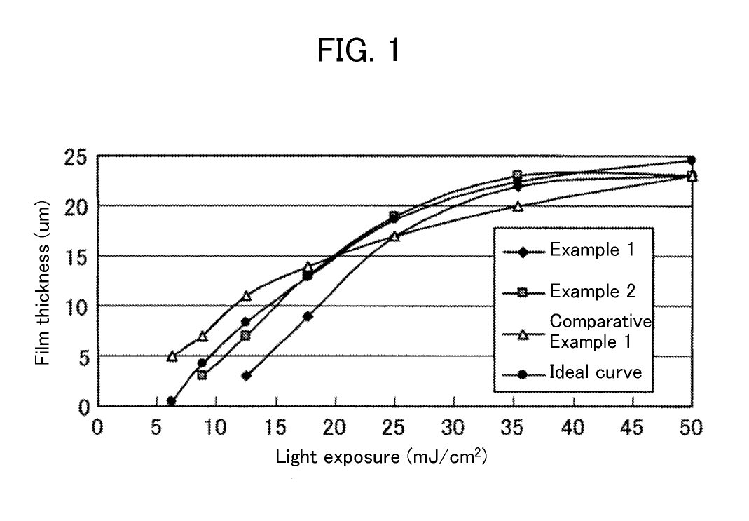

The thickness (film thickness) variations in the width directions of three kinds of three-dimensional micro-molded products made of resin which were obtained as mentioned above were measured, and then relationships between the thickness and the light exposure were determined. FIG. 1 shows a graph illustrating the relationships between the thickness (μm) and the light exposure (mJ/cm²). In FIG. 1, the profile drawn by plotting points is an ideal profile of the micro lens assumed as the objective three-dimensional micro-molded product.

It was described above that the relationship between the cured film thickness and the light exposure preferably corresponds to each other in equal proportion. It is desired that an approximately linear profile on a graph with an ordinate representing the cured film thickness and the abscissa representing the light exposure be obtained when this light exposure and cured film thickness vary proportionally to each other. The steeper the slope of the profile in this case is, the superior the sensitivity of the photosensitive resin composition is. Judging from the subject exposure formation of the three-dimensional micro-molded product from the viewpoint of this sensitivity (slope), formation is hardly conducted with accuracy when the surface of the molded product has a steep shape like for example, a pyramid, with less variations of the cured film thickness for the light exposure, in other words, if the sensitivity is comparatively low. In a molded product having a steep surface shape, it is required that sensitivity is high, in other words, a slope of the linear profile to be large to some extent. On the contrary, in the case in which a molded product having a surface shape with a comparatively gradual variation such as a lens is formed by exposure, the surface shape with the gradual variation is hardly actualized and an uneven surface shape is likely to be actualized when the sensitivity is too high. To form the surface shape with a gradual variation by exposure, a resin composition in which the sensitivity is comparatively lowered, in other words, the slope of the line profile is a comparatively small needs to be used. Accordingly, the ideal slope of the profile varies depending on the surface shape of the intended three-dimensional micro-molded product. Thus, it is important that an ideal profile is determined every subject three-dimensional micro-molded product to be formed and then the component, and constitution and the preparation conditions of the resin composition are finely adjusted so as to approximate to the ideal slope as close as possible. The graph shown in FIG. 1 is determined by assuming a micro lens used for the optical system in electronic equipment.

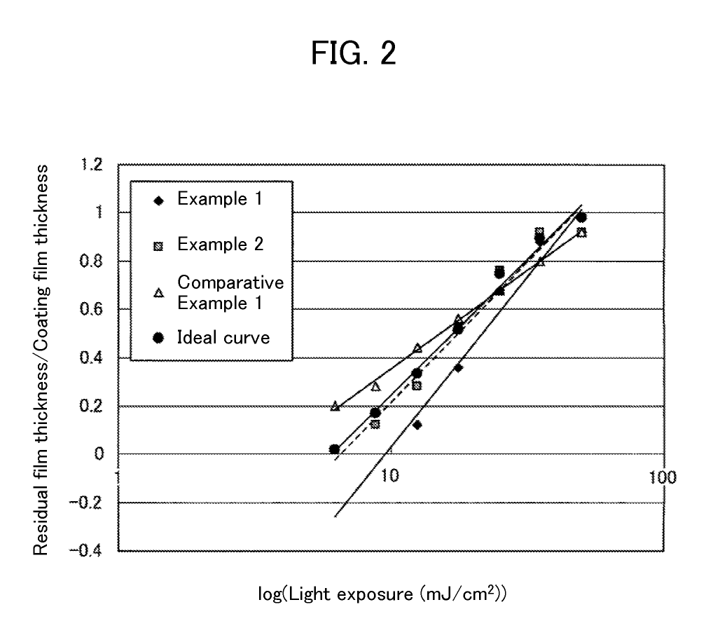

It is confirmed that the relationship between the cured film thickness and the light exposure was in sufficiently equal proportion; however, the ideal profile and a practical allowable range are hardly confirmed. Therefore, the ideal profile and four kinds of profiles in Examples 1 and 2 and Comparative example 1 were standardized to avoid variation by the measure. For the standardization, logarithm of light exposure x (mJ/cm²) is represented by Ln(x), and the cured film thickness (resin cured amount) to the light exposure is represented by the ratio (y=Δh/h) of the residual film thickness Δh (μm) after development to the coating film thickness h (μm) before development. The results are shown in FIG. 2. It was proved that the abovementioned proportionality exhibited linearity and a constant slope range. The line of the ideal profile was y=0.4897Ln(x)−0.8846; the line of the profile in Example 1 was y=0.6117Ln(x)−1.377; the line of the profile in Example 2 was y=0.5078Ln(x)−0.96; and the line of the profile in Comparative Example 1 was y=0.3545Ln(x)−0.4639.

It was confirmed that a falling within the range where 0.35≦α≦0.78 was allowable in practical use when a lot of micro lenses were formed in practice by using the photosensitive dry film using three kinds of the photosensitive resin compositions, and a formula indicating the x-y relations was represented by the general formula of y=α·Ln(x)±β.

The value of α is most suitable for a micro lens; however, great differences are not found among the surface shapes even if practical various micro-molded products are contemplated. Thus, it can be concluded that the photosensitive resin composition having α set to fall within the above numerical value range can be applied to the exposure formation of almost all of the three-dimensional micro-molded products.

In addition, when the pencil hardness of the three-dimensional micro-molded products of the samples (Examples 1 and 2 and Comparative Example 1) was measured, all samples showed the hardness value of H or more.

### INDUSTRIAL APPLICABILITY

The photosensitive dry film according to the present invention can accomplish the lithography formation, with high efficiency and high accuracy, of the three-dimensional micro-molded products conducted by the back face exposure method. In addition, according to the photosensitive resin composition for producing a three-dimensional micro-molded product of the present invention, the three-dimensional micro-molded product having various three-dimension faces can be produced with high accuracy because cured amount to the actinic light exposure can be easily controlled.

1. A photosensitive dry film for producing a three-dimensional micro-molded product comprising at least a cover film and a photosensitive resin composition layer formed thereon, wherein a cured latent image of the three-dimensional micro-molded product is formed inside by irradiating actinic rays from the side of a transparent substrate so that a light volume varies along the plane surface of the transparent substrate after the photosensitive resin composition layer is laminated on the transparent substrate, and the photosensitive resin composition layer is formed by applying a photosensitive resin composition comprising a resin component containing a polymerizable monomer having at least one functional group as a main component and a photoinitiator, followed by drying thereof.

2. The photosensitive dry film for producing the three-dimensional micro-molded product according to claim 1, wherein when the coating film of the photosensitive resin composition was exposed and developed at an exposure wavelength of 390 to 430 nm, the obtained cured film has exposure characteristics provided that a light exposure is represented by x (mJ/cm2), and that the cured film thickness to the light exposure is represented by the ratio (y=Δh/h) of the residual film thickness Δh (μm) after development to the coating film thickness h (μm) before development, the relationship between logarithm of x (Ln(x)) and y is represented by y=α·Ln(x)±β, and α falls within the range of 0.35≦α≦0.78.

3. The photosensitive dry film for producing the three-dimensional micro-molded product according to claim 1, wherein the photosensitive resin composition comprises at least either of a dialkylbenzophenone-based compound and a hexaarylbisimidazole-based compound as a photoinitiator.

4. The photosensitive dry film for producing the three-dimensional micro-molded product according to claim 1, wherein the photosensitive resin composition comprises at least one kind of a compound having a polymerizable tetra- or higher-functional ethylenic unsaturated group in one molecule as a polymerizable monomer in the components.

5. A photosensitive resin composition having a photosensitivity of 0.35≦α≦0.78 when a light exposure of actinic rays (mJ/cm2) is represented by x, a cured film thickness to the light exposure is represented by a ratio (y=Δh/h) of a residual film thickness Δh (μm) after development to a coating film thickness h (μm) before development, whereby the photosensitivity is determined based on the relational expression between x and y, which is y=α·Ln(x)±β.

6. The photosensitive resin composition according to claim 5 comprising a resin component containing a polymerizable monomer having at least one functional group as a main component, and a photoinitiator as chemical components, wherein at least either of a dialkylbenzophenone-based compound and a hexaarylbisimidazole-based compound is included as the photoinitiator.

7. The photosensitive resin composition according to claim 5, comprising a resin component containing a polymerizable monomer having at least one functional group as a main component, and a photoinitiator as chemical components, wherein at least either of a dialkylbenzophenone-based compound and a hexaarylbisimidazole-based compound is included as the photoinitiator.
